(19) United States
(12) Patent Application Publication
(10) Pub. No.: US 2021/0015713 A1
(43) Pub. Date: Jan. 21, 2021

(54) MEDICAL FEEDING TUBE BRACKET APPARATUS, AND A METHOD OF MAKING AND USING SAME

(71) Applicant: Angelo DeStefano, Gardiner, NY (US)

(72) Inventor: Angelo DeStefano, Gardiner, NY (US)

(21) Appl. No.: 16/929,078

(22) Filed: Jul. 14, 2020

Related U.S. Application Data
(60) Provisional application No. 62/874,498, filed on Jul. 15, 2019.

(51) Int. Cl. A61J 15/00

(52) U.S. Cl. CPC A61J 15/0053; F16B 2/005

(57) ABSTRACT

The present invention relates generally to a medical feeding rube bracket apparatus, and a method of making and using same. More particularly, the invention encompasses a substantially U-shaped bracket having a base, having two end walls, and where each of the end walls have at least one opening or slot for the passage of a flexible feeding tube, and each of the end walls have a tube holding slot to securely hold the inserted flexible feeding tube. The substantially U-shaped bracket could also have at least one securing clamp secured thereto, which securing clamp could securely hold the substantially U-shaped bracket to another object. The substantially U-shaped bracket could also have at least one feeding tube support member to hold, and support the inserted flexible feeding tube.

### CROSS-REFERENCE TO RELATED APPLICATION

The instant patent application claims priority to and the benefit of pending U.S. Provisional Patent Application Ser. No. 62/874,498, filed on Jul. 15, 2019, titled “Feeding Tube Bracket Apparatus, And A Method Of Using Same,” the entire disclosure of which provisional application is incorporated herein by reference.

### FIELD OF THE INVENTION

The present invention relates generally to a medical feeding tube bracket apparatus, and a method of making and using same. More particularly, the invention encompasses a substantially U-shaped bracket having, a base, having two end walls, and where each of the end walls have at least one opening or slot for the passage of a flexible feeding tube, and each of the end walls have a tube holding slot to securely hold the inserted flexible feeding tube. The substantially U-shaped bracket could also have at least one securing clamp secured thereto, which securing clamp could securely hold the substantially U-shaped bracket to another object. The substantially U-shaped bracket could also have at least one feeding tube support member to hold, and support the inserted flexible feeding tube.

### BACKGROUND INFORMATION

Feeding tubes have been known in the medical industry for man years, and the feeding tube industry has addressed their well-known problems in a variety of ways, and which are well known to the people skilled in the art.

People in long-term care with impaired caloric or fluid intake, and a functional gastrointestinal tract, are provided with enteral nutrition through the use of a feeding tube. It has been reported that a sizeable number of nursing home residents receive their daily meal or feedings via a feeding tube.

Enteral feeding refers to intake of food via the gastrointestinal (GI) tract. The GI tract is composed of the mouth, esophagus, stomach, and intestines. Enteral feeding may mean nutrition taken through the mouth or through a tube that goes directly to the stomach or small intestine.

It has been observed that small amounts of stomach contents, water or formula leaking from the stoma are common, but too much leakage can cause skin irritation, breakdown, and enlargement of the stoma. Leakage may be caused by tube movement, granulation tissue, a cracked tube, infection, and conditions that increase pressure in the stomach.

Unfortunately a leaky stoma site is very common and creates a messy site, and is stressful for the care giver, as he or she has to clean, clear, and sanitize the messy site, and of course it is also very stressful, and unhygienic for the person being feed via a feeding tube.

Currently, there are two major types of leaks. The first is caused by a leaking feeding tube, where the formula or stomach contents leak out of the device itself. And, the second is a leak from the stoma site (the hole in the body through which the device is secured). This invention addresses both of these types of content leaks.

There are many things that can contribute to stoma site leakage. Some of the most common are:

Incorrectly-sized tube. A tube that is too big or too small can cause a lot of problems, including a leaky stoma site. Most commonly, stoma leakage will occur if the stoma length of the tube is too long. One solution to this problem is to have a properly-sized tube that has a space in-between the external bumper of the tube, and the skin.

Low water level in the balloon. The water level in the balloon needs to be checked periodically. If the water levels get low, the tube may become loose and cause formula and gastric fluids to leak out of the stoma. The loss of water overtime is normal, however, one must periodically check to make sure that the balloon doesn't itself have a small hole in it.

Stomach Residual. If the stomach is too full of gastric fluid and formula food, one may be getting too much nutrition at one time. If the patient is being bolus feed, then one solution is continuous feeding. However, if continuous feeding is causing the problem, then one solution is to decrease the flow rate.

Gas. Just like one's stomach can be too full of food, it can also be too full of gas. If this is the case, then one solution is the need to release the air or gas before or after feeding. This process is called venting.

This problem becomes more pronounced, especially for infants or people who cannot properly communicate their soiled or wet body or clothes. Thus, this invention provides an apparatus, and a method of using the device to eliminate these problems.

This invention also improves on the deficiencies of the prior art and provides a novel medical feeding tube bracket apparatus, and a method of making and using same.

### PURPOSES AND SUMMARY OF THE INVENTION

The invention is a novel medical feeding tube bracket apparatus, and a method of making and using same.

Therefore, one purpose of this invention is to provide an inventive medical feeding tube bracket apparatus, and a method of making and using same.

Another purpose of this invention is to provide a substantially U-shaped bracket having a base, having two end walls, and where each of the end walls have at least one opening or slot for the passage of a flexible feeding tube, and each of the end walls have a tube holding slot to securely hold the inserted flexible feeding tube.

Yet another purpose of this invention is to provide a substantially U-shaped bracket that has at least one securing clamp secured thereto, which securing clamp securely hold the substantially U-shaped bracket to another object.

Still yet another purpose of this invention is to provide a substantially U-shaped bracket that could also have at least one feeding tube support member to hold and support an inserted flexible feeding tube.

Therefore, in one aspect this invention comprises a medical feeding tube bracket apparatus, comprising:
(a) a base having a first end and a second end;
(b) a first side wall having a first end and a second end, and wherein said second end has at least one opening which is connected to a first feeding tube holding slot;
(c) a second side wall having a first end and a second end and wherein said second end has at least one opening which is connected to a second feeding tube holding slot; and
(d) said first end of said base is connected to said first end of said first sidewall, and said second end of said base is connected to said first end of said second sidewall, so as to form said medical feeding tube bracket apparatus.

In another aspect this invention comprises a method of using a medical feeding tube bracket apparatus comprising the steps of:
(a) taking a medical feeding tube bracket apparatus, wherein said medical feeding tube bracket apparatus, comprises:
(b) a base having a first end and a second end;
(c) a first side wall having a first end and a second end, and wherein said second end has at least one opening which is connected to a first feeding tube holding slot;
(d) a second side wall having a first end and a second end, and wherein said second end has at least one opening which is connected to a second feeding tube holding slot;
(e) said first end of said base is connected to said first end of said first sidewall, and said second end of said base is connected to said first end of said second sidewall; and
(f) taking said medical feeding tube bracket apparatus and inserting a first flexible feeding tube having a first end and a second end via said at least one first opening, and placing it against said first feeding tube holding slot;
(g) inserting a second flexible feeding tube having a first end and a second end via said at least one first opening, and placing it against said second feeding tube holding slot;
(h) connecting said first end of said first flexible feeding tube to a first end of a tube connector, and connecting said second end of said first flexible feeding tube to at least one feeding pouch; and
(i) connecting said first end of said second flexible feeding tube to a second end of said tube connector, and connecting said second end of said second flexible feeding tube to a stomach of a human being.

### BRIEF DESCRIPTION OF THE DRAWINGS

FIG. 1, is a perspective view of a first embodiment of the invention showing the inventive feeding tube bracket.

FIG. 2, is a side or end view of an end wall of the inventive feeding tube bracket shown in FIG. 1.

FIG. 3, is a perspective view of a second embodiment of the invention showing the inventive feeding tube bracket.

FIG. 4, is a perspective view of a third embodiment of the invention showing the inventive feeding tube bracket.

FIG. 5, is a perspective view of a fourth embodiment of the invention showing the inventive feeding tube bracket while in use.

### DETAILED DESCRIPTION

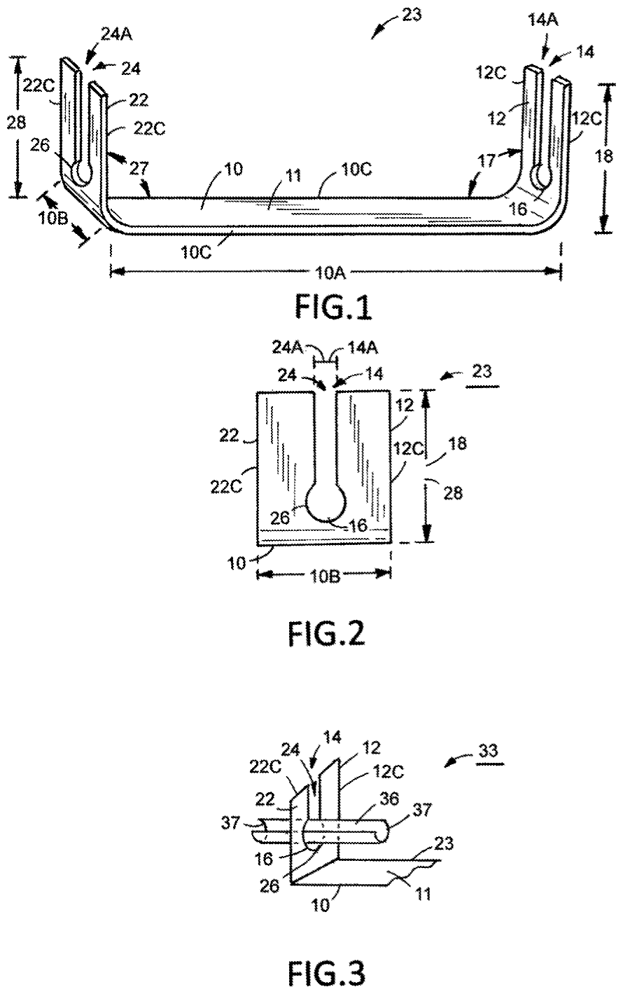

The inventive medical feeding tube bracket apparatus, and a method of making and using same will now be discussed with reference to FIGS. 1 through 5. Although the scope of the present invention is much broader than any particular embodiment, a detailed description of the preferred embodiment follows together with drawings. These drawings are for illustration purposes only and are not drawn to scale. Like numbers represent like features and components in the drawings.

In summary the invention is a medical feeding tube bracket apparatus, and a method of making and using same.

FIG. 1, is a perspective view of a first embodiment of the invention showing the inventive feeding tube bracket 23, having a base 10, with a base edge 10C, a first side or end wall 12, having an edge 12C, connected to a first end of the base 10, and a second side or end wall 22, having an edge 22C, connected to a second end of the base 10. The base 10, preferably has a substantially planar surface 11. The open end of the first end wall 12, has at least one first opening or slot 14, for the easy passage of at least one flexible feeding tube 56, 66, and at least one first feeding tube holding slot 16, to securely hold the at least one flexible feeding tube 56, 66, and to prevent the flexible feeding tube 56, 66, from slipping, and sliding out of the flexible tube insertion slot 14. Similarly, the open end of the second end wall 22, has at least one second opening or slot 24, for the easy passage of at least one flexible feeding tube 56, 66, and at least one second feeding tube holding slot 26, to securely hold the at least one flexible feeding tube 56, 66, and to prevent the flexible feeding tube 56, 66, from slipping, and sliding out of the flexible tube insertion slot 24. The inventive feeding tube bracket 23, preferably has a substantially U-shape shape so as to be able to securely hold at least two different flexible feeding tubes 56, 66, at each end. The inventive feeding tube bracket 23, has a length 10A, and a width 10B, while the first end wall 12, has a height 18, and the second end wall 22, has a height 28. The first end wall 12, makes an angle 17, with the base 10, while the second end wall 22, makes an angle 27, with the base 10. For some applications it is preferred that the angle 17, 27, made between the end walls 12, 22, and the common base 10, is substantially at a right angle, or is substantially at a 90 degrees angle, or that the end walls 12, 22, are substantially vertical when compared to the horizontal base 10. For one embodiment the length 10A, was about 3 inches, while the width 10B, was about 1.20 inches. However, the length 10A, and the width 10B, for the inventive feeding tube bracket 23, could be of any dimension, as long as it can be used as intended. The first opening or slot 14, could have a width opening 14A, while the second opening or slot 24, could have a width opening 24A. In one embodiment for a 5/16 inch diameter flexible feeding tube 56, 66, one could have a width opening 14A, 24A, of say about 0.25 inches, which opening is sufficiently wide to allow the easy passage of the flexible feeding tube 56, 66, through the slot 14, 24, but narrow enough to prevent the sliding out of the flexible feeding tube 56, 66, from the tube holding slot 16, 26. Thus, it should be appreciated that the flexible feeding tube 56, 66, is pinched when it is gently inserted in the slot 14, 24, but then the flexible feeding tube 56, 66, naturally or automatically expands when it reaches the feeding tube holding slot 16, 26. For some applications the inventive feeding tube bracket 23, could be one continuous piece, which has been bent at the first end of the base 10, to form a first side wall 12, and then it is bent at the second end of the base 10, so as to form a second side wall 22. However, for some applications one could have the inventive feeding tube bracket 23, comprising of three different pieces, namely, the base 10, the first side wall 12, the second side wall 22, and where the first side wall 12, is secured to a first end of the base 10, while the second side wall 22, would be secured to the second end of the base 10, so as to form a substantially U-shaped inventive feeding tube bracket 23.

FIG. 2, is a side or end view of an end wall of the inventive feeding tube bracket 23, shown in FIG. 1. As one can appreciate that the opening or slot 14, 24, having a width opening 14A, 24A, respectively, are wide enough for the easy insertion or passage of the flexible feeding tube 56, 66, and that the feeding tube holding slot 16, 26, is wide enough to freely accommodate the flexible feeding tube 56, 66, and is wide enough to allow the flexible feeding tube 56, 66, to fully expand to its natural diameter shape and stay in place. As one can also further appreciate that the width opening 14A, 24A, will depend upon the width or diameter of the flexible feeding tube 56, 66, while the feeding tube holding slot 16, 26, should be wide enough to freely accommodate the flexible feeding tube 56, 66, in its natural or expanded condition.

FIG. 3, is a perspective view of a second embodiment of the invention showing the inventive feeding tube bracket 33, having a base 10, and two end or side walls 12, 22, where each of the end walls 12, 22, have at least one opening or slot 14, 24, for the easy passage or insertion of at least one flexible feeding tube 56, 66, and at least one feeding tube holding slot 16, 26, to securely hold the flexible feeding tube 56, 66, and to prevent the flexible feeding tube 56, 66 from slipping and sliding out of the opening or slot 14, 24. The inventive feeding tube bracket 33, can optionally have at least one feeding tube support member 36, where the flexible feeding tube 56, 66, can rest or be stabilized while in use. It should be understood that curvature 37, of the feeding tube support member 36, is substantially congruent to an outside diameter 57, 67, of the flexible feeding tube 56, 66.

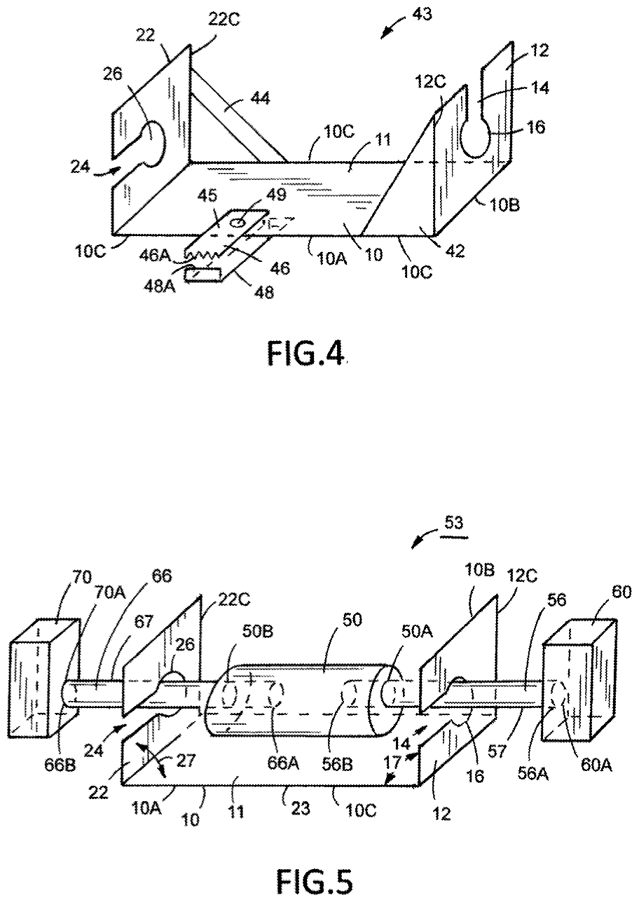

FIG. 4, is a perspective view of a third embodiment of the invention showing the inventive feeding tube bracket 43, having a base 10, and two end or side walls 12, 22 where each of the end walls 12, 22, have at least one opening or slot 14, 24, for the easy insertion or passage of at least one flexible feeding tube 56, 66, and at least one feeding tube holding slot 16, 26, to securely hold a flexible feeding tube 56, 66, and to prevent the flexible feeding tube 56, 66, from slipping and sliding out of the opening or slot 14, 24. The inventive feeding tube bracket 43, can optionally have at least one brace or side support or side strut 42, 44, that connects an edge 12C, 22C, of the end wall 12, 22, to an edge 10C, of the base 10, so as to provide additional structural support to the inventive feeding tube bracket 43. The inventive feeding tube bracket 43, can optionally have at least one clamp or locking clamp 45, which can be used to clamp or lock the inventive feeding tube bracket 43, to a suitable location or object (not shown), so as to prevent or limit the movement of the inventive feeding tube bracket 43. The at least one clamp or locking clamp 45, is secured to the inventive feeding tube bracket 23, 33, 43, via at least one securing means 49, and wherein the at least one securing means 49, could be selected from a group comprising glue, rivet, weld, nut and bolt means, adhesive, screw, hook and loop means, and combinations thereof, to name a few. The at least one clamp or locking clamp 45, preferably has a first or upper clamping means 46, and a second or lower clamping means 48. For some applications the first clamping means 46, could have grabbing means 46A, such as, for example, teeth 46A, jaws 46A, serration 46, and combinations thereof, to name a few. For some application the second clamping means 48, could be engaging means 48A, such as, for example, an edge 48A, a surface 48A, and combinations thereof, to name a few.

FIG. 5, is a perspective view of a fourth embodiment of the invention showing the inventive feeding tube bracket 53, while in use. The inventive feeding tube bracket 53, has a base 10, and two end or side walls 12, 22, where each of the end walls 12, 22, have at least one opening or slot 14, 24, for the easy passage or insertion of at least one first flexible feeding tube 56, and at least one second flexible feeding tube 66, and at least one feeding tube holding slot 16, 26, to securely hold the first flexible feeding tube 56, and the second flexible feeding tube 66, in their respective holding slots 16, 26, and to prevent the first flexible feeding tube 56, and the second flexible feeding tube 66, from slipping, and sliding, out of the narrow opening 14A, 24A, or slot 14, 24. The at least one first flexible feeding tube 56, has a first bag tube end 56A, and a second bag tube end 56B, while the at least one second flexible feeding tube 66, has a first stoma tube end 66A, and a second stoma tube end 66B. At least one tube connector 50, having a first tube connector end 50A, and a second tube connector end 50B, connects the at least one first flexible feeding tube 56, to the at least one second flexible feeding tube 66. It should be appreciated that the first bag tube end 56A, is in secure contact with a feeding pouch or bag 60, via an pouch opening 60A, while the second bag tube end 56B, is removably and securely engaged with the first bag tube end 56A. Similarly, the second stoma tube end 66B, is in secure contact with a stoma or stomach 70, of a human being 70, via a stoma opening 70A, while the first stoma tube end 66A, is removably and securely engaged with the second feeding tube end 50B. As one can see in FIG. 5, that one end 56A, of the at least one first flexible feeding tube 56, is connected to a feeding bag or feeding pouch 60, while the other end 56B, is secured inside a first end 50A, of the at least one tube connector 50. Similarly, one end 66B, of the at least one second flexible feeding tube 66, is connected to a stoma or stomach 70, of a human being 70, while the other end 66A, is secured inside a second end 50B, of the at least one feeding tube connector 50. FIG. 5, clearly shows that the at least one first flexible feeding tube 56, the at least one second flexible feeding tube 66, and the at least one feeding tube connector 50, are securely held in place by the inventive feeding tube bracket 23, as the flexible feeding tube 56, 66, between the feeding pouch or bag 60, and the stoma 70, could flexibly move around, but their connection at the tube connector 50, is secure and fixed, and is supplemented by the inventive feeding tube bracket 23, 33, 43.

The inventive feeding tube bracket 23, 33, 43, when in use allows a first flexible feeding tube 56, to be securely being held in place in the first feeding tube holding slot 16, at the first end wall 12, while the second flexible feeding tube 65, is securely being held in place in the second feeding tube holding slot 26, at the second end wall 22, while the second end 56B, of the first flexible feeding tube 56, and the first end 66A, of the second flexible feeding tube 66, are securely being held in place by the tube connector 50, and where the first flexible feeding tube 56, and the second flexible feeding tube 66, and the tube connector 50, are securely being held in place by the inventive feeding tube bracket 23, 33, 43.

The inventive feeding tube bracket 23, 33, 43, can be made from any medically approved material, and where the medically approved material could be selected front a group comprising a plastic material, medical grade silicone material, silicone material, polycarbonate, polypropylene, polyethylene, custom polymers meeting medical device application material, ABS (acrylonitrile-butadiene-styrene) material, metal material, metal alloy material, ceramic material, stainless steel material, a composite material, and combinations thereof, to name a few. A medically approved material is typically a biocompatibility material, and as such has properties which must be biologically compatible, and not react to other materials or living tissue. Since many medical applications involve materials coming in contact with human tissue, materials are tested for biocompatibility in order to receive a medical grade title.

The present invention is not limited to the embodiments described herein and the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions.

It should be further understood that throughout the specification and claims several terms have been used and they take the meanings explicitly associated herein, unless the context clearly dictates otherwise. For example, the phrase “in one embodiment” as used herein does not necessarily refer to the same embodiment, though it may. Additionally, the phrase “in another embodiment” as used herein does not necessarily refer to a different embodiment, although it may. Thus, various embodiments of the invention may be readily combined, without departing from the scope or spirit of the invention.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A medical feeding tube bracket apparatus, comprising:
(a) a base having a first end and a second end;
(b) a first side wall having a first end and a second end, and wherein said second end has at least one opening which is connected to a first feeding tube holding slot;
(c) a second side wall having a first end and a second end, and wherein said second end has at least one opening which is connected to a second feeding tube holding slot; and
(d) said first end of said base is connected to said first end of said first sidewall, and said second end of said base is connected to said first end of said second sidewall, so as to form said medical feeding tube bracket apparatus.

2. The medical feeding tube bracket apparatus of claim 1, wherein said first feeding tube holding slot has secured thereto a feeding tube support member.

3. The medical feeding tube bracket apparatus of claim 1, wherein said second feeding tube holding slot has secured thereto a feeding tube support member.

4. The medical feeding tube bracket apparatus of claim 1, wherein at least one bracket secures an edge of said first side wall to an edge of said base.

5. The medical feeding tube bracket apparatus of claim 1, wherein at least one bracket secures an edge of said second side wall to an edge of said base.

6. The medical feeding tube bracket apparatus of claim 1, wherein at least one clamping means are secured to an edge of said base.

7. The medical feeding tube bracket apparatus of claim 1, wherein said first side wall is substantially vertical in relation with said base.

8. The medical feeding tube bracket apparatus of claim 1, wherein said second side wall is substantially vertical in relation with said base.

9. The medical feeding tube bracket apparatus of claim 1, wherein at least one clamping means are secured to an edge of said base using at least one securing means, and wherein said at least one securing means are selected from a group consisting of glue, rivet, weld, nut and bolt means, adhesive, screw, hook and loop means, and combinations thereof.

10. The medical feeding tube bracket apparatus of claim 1, wherein at least one clamping means are secured to an edge of said base, and wherein said at least one clamping means has a first clamping means, and a second clamping means.

11. The medical feeding tube bracket apparatus of claim 1, wherein at least one clamping means are secured to an edge of said base, and wherein said at least one clamping means has a first clamping means, and a second clamping means, and wherein said first clamping means has a grabbing means, and wherein said grabbing means is selected from a group consisting of teeth, jaws, serration, and combinations thereof.

12. The medical feeding tube bracket apparatus of claim 1, wherein at least one clamping means are secured to an edge of said base, and wherein said at least one clamping means has a first clamping means, and a second clamping means, and wherein said second clamping means has engaging means, and wherein said engaging means is selected from a group consisting of an edge, a surface, and combinations thereof.

13. The medical feeding tube bracket apparatus of claim 1, wherein a curvature of said first feeding tube holding slot is substantially congruent with an outside diameter of a first flexible feeding tube.

14. The medical feeding tube bracket apparatus of claim 1, wherein a curvature of said second feeding tube holding slot is substantially congruent with an outside diameter of a second flexible feeding tube.

15. A method of using a medical feeding tube bracket apparatus comprising the steps of:
(a) taking said medical feeding tube bracket apparatus of claim 1, and inserting a first flexible feeding tube having a first end and a second end via said at least one first opening, and placing it against said first feeding tube holding slot;
(b) inserting a second flexible feeding tube having a first end and a second end via said at least one first opening, and placing it against said second feeding tube holding slot;
(c) connecting said first end of said first flexible feeding tube to a first end of a tube connector, and connecting said second end of said first flexible feeding tube to at least one feeding pouch; and
(d) connecting said first end of said second flexible feeding tube to a second end of said tube connector, and connecting said second end of said second flexible feeding tube to a stomach of a human being.

16. The method of using a medical feeding tube bracket apparatus of claim 15, wherein a curvature of said first feeding tube holding slot is substantially congruent with an outside diameter of said first flexible feeding tube.

17. The method of using a medical feeding tube bracket apparatus of claim 15, wherein a curvature of said second feeding tube holding slot is substantially congruent with an outside diameter of said second flexible feeding tube.

18. A method of using a medical feeding tube bracket apparatus comprising the steps of:
(a) taking a medical feeding tube bracket apparatus, wherein said medical feeding tube bracket apparatus, comprises:
(b) a base having a first end and a second end;
(c) a first side wall having a first end and a second end, and wherein said second end has at least one opening which is connected to a first feeding tube holding slot;
(d) a second side wall having a first end and a second end, and wherein said second end has at least one opening which is connected to a second feeding tube holding slot;
(e) said first end of said base is connected to said first end of said first sidewall, and said second end of said base is connected to said first end of said second sidewall; and
(f) taking said medical feeding tube bracket apparatus and inserting a first flexible feeding tube having a first end and a second end via said at least one first opening, and placing it against said first feeding tube holding slot;
(g) inserting a second flexible feeding tube having a first end and a second end via said at least one first opening, and placing it against said second feeding tube holding slot;
(h) connecting said first end of said first flexible feeding tube to a first end of a tube connector, and connecting said second end of said first flexible feeding tube to at least one feeding pouch; and
(i) connecting said first end of said second flexible feeding tube to a second end of said tube connector, and connecting said second end of said second flexible feeding tube to a stomach of a human being.
